(19) United States
(12) Patent Application Publication
(10) Pub. No.: US 2025/0367694 A1
(43) Pub. Date: Dec. 4, 2025

(54) DISPENSER

(71) Applicant: SILGAN DISPENSING SYSTEMS (WUXI) CO. LTD., RICHMOND, VA (US)

(72) Inventor: XI LI, WUXI (CN)

(73) Assignee: SILGAN DISPENSING SYSTEMS (WUXI) CO. LTD., RICHMOND, VA (US)

(21) Appl. No.: 18/875,384

(22) PCT Filed: Jun. 1, 2023
(86) PCT No.: PCT/CN2023/097711

§ 371 Date: Dec. 16, 2024

(30) Foreign Application Priority Data
Jun. 14, 2022 (CN) 202210667233.1

(51) Int. Cl. B05B 11/10

(52) U.S. Cl. CPC B05B 11/1081; B05B 11/1001; B05B 11/1047

(57) ABSTRACT

The present invention discloses a dispenser, comprising: a first reservoir and a second reservoir for storing different products, with the second reservoir partially located within the first reservoir; an actuator operated by a user; a bushing having a lower end partially extending into the first reservoir; a collar engaged with the actuator such that the collar can be pushed by the actuator to axially displace, wherein the collar has a lower end partially extending into the bushing; a pump fixedly arranged within the collar, and having an inlet which is communicated with the first reservoir, and an outlet which is communicated with a nozzle of the dispenser; a piston engaged with the lower end of the collar, and configured to be pushed by the collar to slide within the bushing in a sealed manner; and a sealing cap engaged with the lower end of the bushing in a sealed manner, and configured to be pushed by the piston to axially displace, wherein the dispenser is configured to have a first configuration with the actuator being not pushed, a second configuration for mixing the products, and a third configuration for dispensing the products.

### FIELD OF THE INVENTION

The present invention generally relates to a dispenser, in particular to a dispenser for storing, mixing, and dispensing two different products. These two products can be liquid or powder. The dispenser in accordance to the present invention can be used in fields such as daily chemical, medical, chemical, etc., for example, for dispensing cosmetics, drugs, reagents, etc.

### BACKGROUND OF THE INVENTION

Patent EP1227993B1 discloses a dispenser comprising a dispensing member and two reservoirs separated by a partition. The dispenser member further comprises a displacement means, namely a ring, for moving the dispensing member towards the partition to cause it to give way or collapse, and thus to enable contents of the two reservoirs to be mixed prior to being dispensed. The dispensing member can be moved in the direction of the common partition between an initial position in which the two reservoirs are separated by the partition, and a final position in which the partition has given way under the pressure of the dispensing member. The dispensing member can therefore move in a translatory direction in the direction of the partition.

The dispensing member is attached to the first reservoir by a ring. By pressure on the ring, a latching profile can be brought out of a latching groove and to snap into a second latching groove of a neck. During this movement, a plunger tube has translated towards the partition so as to make it yield.

A first drawback of the solution disclosed in EP1227993 is that an actuation button can be actuated inadvertently, for example, when actuating the ring, causing dispense of fluid prior to mixing two products. A second drawback is that the ring is uneasy to be grasped and actuated. There is a need for a dispenser equipped with two reservoirs, the contents of which have to be mixed with an optimized ergonomics.

### SUMMARY OF THE INVENTION

The present invention solves the above problem by providing a dispenser. The dispenser in accordance to the present invention comprises: a first reservoir for storing a first product; a second reservoir partially located within the first reservoir and used for storing a second product different from the first product; an actuator configured to be operated by a user; a bushing having a lower end which partially extends into the first reservoir; a collar engaged with the actuator such that the collar can be pushed by the actuator to axially displace, wherein the collar has a lower end partially extending into the bushing; a pump fixedly arranged within the collar, and having an inlet which is communicated with the first reservoir, and an outlet which is communicated with a nozzle of the dispenser; a piston engaged with the lower end of the collar, and configured to be pushed by the collar to slide within the bushing in a sealed manner; and a sealing cap engaged with the lower end of the bushing in a sealed manner, and configured to be pushed by the piston to axially displace, wherein the second reservoir is defined by the bushing, the piston, and the sealing cap, wherein the dispenser is configured to have a first configuration in which the actuator is not pushed and the first reservoir is separated from the second reservoir by the sealing cap, a second configuration in which the actuator is pushed to axially displace the collar and the piston such that the sealing cap is pushed to disengage from the bushing, thereby allowing the second product to enter the first reservoir to mix with the first product and form a mixture, and a third configuration in which the actuator is further pushed to activate the pump, thereby dispensing the mixture.

In the dispenser in accordance to the present invention, the operation of the dispenser is achieved by pushing (for example, pressing) the actuator, making the operation simpler and more convenient. At the same time, the mixing and dispensing operations of the product are carried out successively in two configurations, thereby avoiding the risk of dispensing the products before mixing them.

Advantageously, the dispenser further comprises a spring located between the bushing and the collar to bias the collar axially.

Preferably, the collar comprises an inner sleeve, and an annular base located on an outer surface of the inner sleeve, wherein a pump body of the pump is fixedly arranged within the inner sleeve, and the piston is engaged with a lower end of the inner sleeve.

Preferably, the dispenser further comprises a closure arranged around the collar, wherein the closure comprises an annular wall, and a plurality of axial grooves arranged along an inner surface of the annular wall, and wherein the collar comprises a plurality of outer legs extending axially upwards from the annular base, and each outer leg axially slidably engages into the respective axial groove.

Preferably, the outer leg of the collar comprises a projection radially outwards protruding from a top of the outer leg, wherein the closure comprises a notch located at an upper end of the axial groove, and wherein in the third configuration of the dispenser, the projection axially slidably engages into the notch to allow axial displacement of the collar relative to the closure, and an axial bottom of the notch forms a stop for the projection to prevent further axial displacement of the collar relative to the closure.

Preferably, the actuator comprises an outer actuator operated by the user, and an inner actuator fixedly connected to the outer actuator, wherein the inner actuator has a plurality of lower legs extending axially downwards, the adjacent lower legs being separated by a recess, and wherein the collar has a plurality of inner ribs extending axially upwards from the annular base, and the inner ribs are located radially inside the respective outer legs and axially slidably engage into the recesses.

Preferably, the collar comprises hinged arms each located between the adjacent outer legs and extending axially upwards from the annular base, the hinged arm being deflectable outwards about a fixed end thereof, and having an inclined top surface at a free end thereof, wherein the inner actuator comprises an annular flange located on outer surfaces of the lower legs, and wherein the annular flange and the hinged arms are configured so that in the first configuration and the second configuration of the dispenser, a lower surface of the annular flange engages with the top surfaces of the hinged arms.

Preferably, the closure comprises windows each located between the adjacent axial grooves and radially perforating through the annular wall, and wherein the annular flange, the hinged arms and the windows are configured so that in the third configuration of the dispenser, the lower surface of the annular flange slides along the top surfaces of the hinged arms and inner surfaces of the hinged arms to deflect the hinged arms outwards through the respective windows.

Preferably, the inner actuator comprises a shoulder located on inner surfaces of the lower legs, so that as the inner actuator displaces downwards, the shoulder of the inner actuator abuts against a top surface of the inner sleeve of the collar.

Preferably, the collar comprises a plurality of pairs of tabs extending axially downwards from the annular base, the plurality of pairs of tabs being located radially outside the inner sleeve, and each pair of tabs being spaced circumferentially, wherein the bushing comprises a barrel section which defines a plurality of axial grooves on an inner surface thereof, and wherein each pair of tabs axially slidably engages into the respective axial groove.

Preferably, each pair of tabs has a pair of circumferentially protruding upper projections and a pair of circumferentially protruding lower projections on a circumferential outer side thereof, wherein each axial groove of the bushing is provided with a pair of circumferential opposite groove flanges at an upper end thereof, and wherein the upper projections, the lower projections and the groove flanges are configured so that in the first configuration of the dispenser, upper sides of the pair of lower projections abut against lower sides of the respective pair of groove flanges, and in the second configuration of the dispenser, the pair of upper projections are axially displaced downwards to pass over the respective pair of groove flanges, and thus upper sides of the pair of upper projections abut against lower sides of the respective pair of groove flanges.

Preferably, a lower surface of the annular base of the collar forms a shoulder, so that as the collar displaces downwards, the shoulder of the collar abuts against a top surface of the bushing.

Preferably, an inner surface of the barrel section of the bushing is provided with an annular inner flange, and wherein the spring is arranged between the annular inner flange of the bushing and the shoulder of the collar.

In one embodiment, the sealing cap comprises a cap body, a hollow shaft extending upwards from the cap body and defining a hole which communicates the inlet of the pump with the first reservoir, an inner groove arranged within the cap body around the hollow shaft, and an outer groove arranged within the cap body and radially spaced outwards from the inner groove, and wherein the lower end of the bushing is engaged in the outer groove of the sealing cap in a sealing manner.

Preferably, the piston comprises a central sleeve, wherein the hollow shaft of the sealing cap is arranged in the central sleeve, and a lower end of the central sleeve is engaged in the inner groove of the sealing cap in a sealing manner. Preferably, the sealing cap further comprises a plurality of support ribs which extend upwards from the cap body, and which surround and bear against the central sleeve of the piston.

In another embodiment, the sealing cap comprises a cap body, a cap sleeve extending upwards from the cap body and defining a hole which communicates the inlet of the pump with the first reservoir, an outer groove arranged in the cap body, and a plurality of cap ribs, the lower end of the bushing being engaged in the outer groove of the sealing cap in a sealing manner, and wherein the plurality of cap ribs extend upwards from the cap body, surround the cap sleeve, and abut against a bottom surface of the piston.

Preferably, the piston comprises a sealing lip which slidably engages with an inner surface of the bushing in a sealing manner, and an annular groove in which the lower end of the collar is engaged.

Preferably, the dispenser further comprises a housing which comprises a first housing defining the first reservoir, and a second housing surrounding the closure.

Preferably, the dispenser further comprises a cap which is sleeved over the second housing.

Preferably, the dispenser further comprises an outer ring which is arranged between the cap and the first housing.

Preferably, the dispenser further comprises a follower piston which is located within the first reservoir.

### BRIEF DESCRIPTION OF DRAWINGS

The present invention is specifically described with reference to examples shown in the drawings, in which:

FIG. 1 shows a schematic sectional view of a first embodiment of a dispenser according to the present invention;

FIG. 2 shows a schematic perspective view of an inner actuator in FIG. 1;

FIG. 3 shows a schematic perspective view of a closure in FIG. 1;

FIG. 4 shows a schematic perspective view of a bushing in FIG. 1;

FIG. 5 shows a schematic perspective view of a collar in FIG. 1;

FIG. 6 shows a schematic perspective view of a piston in the first embodiment;

FIG. 7 shows a schematic perspective view of a sealing cap in the first embodiment;

FIG. 8 shows a schematic perspective view of a variant of the sealing cap in FIG. 7;

FIG. 9 shows a schematic sectional view of a second embodiment of the dispenser according to the present invention, with some components not shown;

FIG. 10 shows a schematic perspective view of the sealing cap in the second embodiment;

FIG. 11 shows a schematic sectional view of a first configuration of the dispenser, with some components not shown;

FIG. 12 shows a schematic sectional view of a second configuration of the dispenser, with some components not shown;

FIG. 13 shows a schematic sectional view of a third configuration of the dispenser, with some components not shown;

FIG. 14 shows a schematic perspective sectional view of the first configuration of the dispenser, with some components not shown;

FIG. 15 shows a schematic perspective sectional view of the second configuration of the dispenser, with some components not shown; and

FIG. 16 shows a schematic perspective sectional view of the third configuration of the dispenser, with some components not shown.

### DETAILED DESCRIPTION OF PREFERRED EMBODIMENTS

To facilitate understanding the present invention, the invention will now be described more fully with reference to the accompanying drawings. Preferred embodiments of the present invention are shown in the drawings. This invention may, however, be embodied in many different forms and should not be construed as limited to the embodiments set forth herein. Rather, these embodiments are provided for fully and completely understanding the disclosure of the present invention.

In the context of the present application, the terms “upper” (or “upper end”, “upper side”), “lower” (or “lower end”, “lower side”), “top” (or “top end”, “top side”), “bottom” (or “bottom end”, “bottom side”) are mentioned with reference to orientation of a dispenser during operation, and are only used for the purpose of explaining the relative positions of components and are not intended to limit the scope of protection of the present invention.

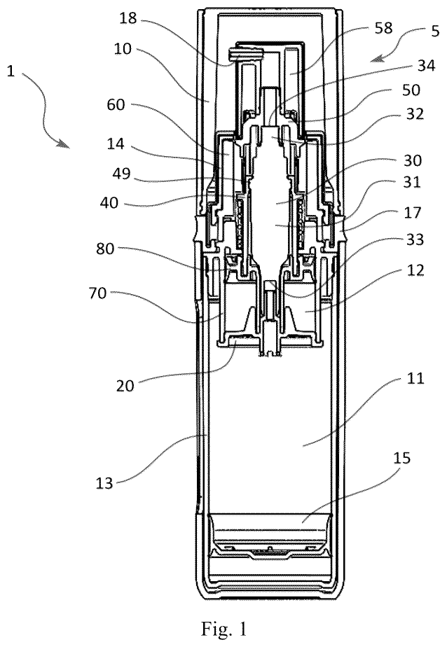

FIG. 1 schematically illustrates a longitudinal sectional view of the first embodiment of the dispenser 1 according to the present invention. As shown in FIG. 1, the dispenser I has a housing substantially formed of a first housing 13 and a second housing 14. An outer actuator 58 extends upwards to the outside of the second housing 14 and comprises a nozzle 18 for dispensing products. A cap 10 is sleeved over the second housing 14 to protect the nozzle 18 and to prevent the dispenser from being inadvertently actuated. For the purpose of aesthetics and easy operation, an outer ring 17 is arranged between the first housing 13 and the cap 10. The housings 13 and 14, the cap 10 and the outer ring 17 can be made of metal, alloy, and/or plastic. The outer sides of the housings 13 and 14 can be further equipped with flexible rubber sleeves, for example, to improve tactility for a user, and to facilitate printing patterns on the outer surface of the dispenser.

The dispenser 1 has a first reservoir 11 and a second reservoir 12. The first reservoir 11 is, for example, a bottle and is generally defined by the first housing 13 to store a first product. The second reservoir 12 is partially located inside the first reservoir 11 and is used to store a second product that is different from the first product. These two products can be either fluid or powder, that is, they can be fluid and fluid, powder and powder, or fluid and powder. The second reservoir 12 is sealed by a sealing cap 20, so that the first reservoir 11 and the second reservoir 12 are separated from each other by the sealing cap 20, and can be communicated with each other by moving the sealing cap 20.

As shown in FIG. 1, the dispenser 1 comprises an actuator 5, a pump 30, a collar 40, a closure 60, a bushing 70, a piston 80, and a sealing cap 20. The actuator 5 comprises the outer actuator 58 pressed by the user and an inner actuator 50 fixedly connected to the outer actuator 58. The collar 40 is generally located below the inner actuator 50 and can be pushed by the actuator 5 to axially displace. A lower end of the collar 40 partially extends into the bushing 70. The pump 30 has a pump body 31 fixedly arranged (for example, snapped) within the collar 40, a stem 32 extending upwards from the pump body 31 and capable of being pushed by the inner actuator 50 to initiate dispensing operation, a pump spring (not shown) located within the pump body 31, an inlet 33 communicated with the first reservoir 11, and an outlet 34 communicated with the nozzle 18. The closure 60 is generally located radially between the collar 40 and the second housing 14, and is fixed relative to the housing. The bushing 70 is fixed relative to the housing and has a lower end that partially extends into the first reservoir 11. The piston 80 is engaged to a lower end of the collar 40 and can be pushed by the collar 40 to slide in a sealed manner within the bushing 70. The sealing cap 20 is sealed to and engaged with the lower end of the bushing 70, and can be pushed by the piston 80 to axially displace. The spring 90 is located between the bushing 70 and the collar 40 to bias the collar 40 axially (see FIG. 11). As shown in FIG. 1, the first product in the first reservoir 11 is enclosed among the first housing 13, a slidable follower piston 15 in the first housing 13, the bushing 70, and the sealing cap 20, and the second product in the second reservoir 12 is enclosed among the bushing 70, the piston 80, and the sealing cap 20.

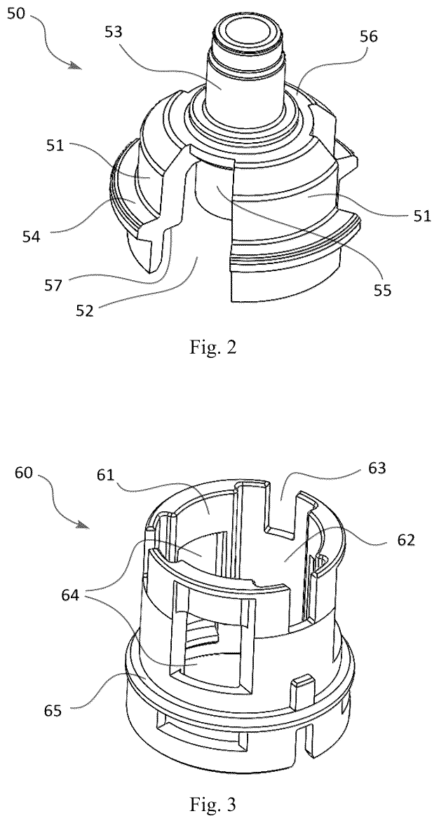

The above components will be explained in detail one by one with reference to the drawings. Referring to FIG. 2 in conjunction with FIG. 1, the inner actuator 50 has a base 56, a hollow column 53 extending upwards from the base 56, a lower sleeve 55 extending downwards from the base 56, and a plurality of lower legs 51 extending downwards from the base 56. The hollow column 53 is fixedly engaged in a corresponding recess of the outer actuator 58, and the lower sleeve 55 is fixedly engaged on (e.g. sleeved over) the stem 32 of the pump 30, so that the pump 30 can be activated by pushing the stem 32 downwards. The inner actuator 50 has a hole that runs through the hollow column 53 and the lower sleeve 55 to communicate the outlet 34 of pump 30 with the nozzle 18 on the outer actuator 58. The lower leg 51 is located radially outside the lower sleeve 55, and adjacent lower legs 51 are spaced circumferentially by a recess 52. These lower legs 51 are generally located on a common cylindrical wall. The figure shows three lower legs 51 and three recesses 52, and more or less lower legs 51 and recesses 52 are conceivable. An annular flange 54 is formed on outer surfaces of the lower legs 51, and a shoulder 57 is formed on inner surfaces thereof. A lower surface of the annular flange 54 may be chamfered or rounded, or may be an inclined surface to facilitate sliding along hinged arms 42 of the collar 40, as detailed below.

Referring to FIG. 3 in conjunction with FIG. 1, the closure 60 is generally surrounded by the second housing 14, and is generally cylindrical in shape. The closure 60 comprises an annular wall 61, a plurality of axial grooves 62 extending on an inner surface of the annular wall 61, notches 63 formed at top portions of the axial grooves 62, and a plurality of windows 64 arranged alternately with the axial groove 62 in a circumferential direction and perforating through the annular wall 61 in a radial direction. The notches 63 may or may not radially perforate the annular wall 61, and extend downwards for a certain distance from upper ends of the axial grooves 62. The figure shows three axial grooves 62, three notches 63, and three windows 64, and more or less number of the components is conceivable. The closure 60 may also comprise an annular flange 65 and other features located on an outer surface of the annular wall 61 to secure the closure 60 to the housing (especially the second housing 14).

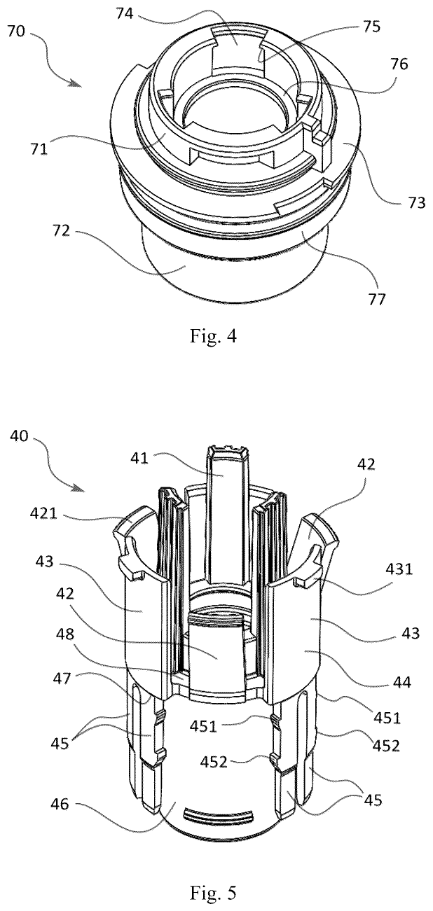

Referring to FIG. 4 in conjunction with FIG. 1, the bushing (also known as a “liner”) 70 is positioned on a neck of the first reservoir 11 and partially defines the second reservoir 12. Specifically, the bushing 70 comprises a barrel section 71 and a cylinder section 72 located below the barrel section 71. An inner surface of the barrel section 71 is provided with an annular inner flange 76 and a plurality of axial grooves 74. A pair of circumferentially opposite groove flanges 75 are provided at an upper end of each axial groove 74, that is, the pair of groove flanges 75 protrude opposite to each other from both sides of the axial groove 74 at the upper end of the axial groove 74. As detailed below, the cylinder section 72 forms the second reservoir 12 with other components. The bushing 70 also comprises an annular outer flange 73 located on an outer surface of the barrel section 71 or of the cylinder section 72 to secure the bushing 70 to the housing (especially the first housing 13). The bushing 70 can also comprise an outer sleeve 77 located radially outside the cylinder section 70, and an outer surface of the outer sleeve 77 can form a sealed engagement with an inner surface of the first housing 13.

Referring to FIG. 5 in conjunction with FIG. 1, the collar 40 comprises an inner sleeve 46 and an annular base 48 located on an outer surface of the inner sleeve 46. The collar 40 further comprises a plurality of outer legs 43 extending axially upwards from the annular base 48, a plurality of hinged arms 42 extending axially upwards from the annular base 48 and alternately arranged with the outer legs 43 in a circumferential direction, a plurality of inner ribs 41 extending axially upwards from the annular base 48, and a plurality of pairs of tabs 45 extending axially downwards from the annular base 48. An inner surface of the inner sleeve 46 can be provided with a snap groove 49 to fix the pump body 31 of the pump 30 within the inner sleeve 46 by means of a snapped connection (see FIG. 9). A lower end of the inner sleeve 46 extends partially into the cylinder section 72 of the bushing 70 and engages with the piston 80 in the cylinder section 72. A lower surface of the annular base 48 forms a shoulder 47. The spring 90 is located between the shoulder 47 and the annular inner flange 76 of the bushing 70, thereby biasing the collar 40 upwards.

The inner rib 41 is located radially inside the respective outer leg 43, and the plurality of inner ribs 41 are generally located on the same circumference. The plurality of inner ribs 41 can be formed from the same annular wall. The inner ribs 41 can move axially in the respective recesses 52 of the inner actuator 50 to guide the displacement of the inner actuator 50. A plurality of axially extending reinforcing ribs can be further arranged on a radial outer surface of each inner rib 41.

A plurality of outer legs 43 are generally located on the same circumference and form an outer surface 44 of the collar 40. A plurality of outer legs 43 can be formed from the same annular wall. The outer legs 43 can slide axially within the respective axial grooves 62 of the closure 60 to guide the axial displacement of the collar 40. A top of the outer leg 43 is provided with a projection 431 that protrudes radially outwards. As the outer leg 43 slides axially downwards along the axial groove 62 of the closure 60, the projection 431 slides along the notch 63 located at the axial groove 62. When the projection 431 slides to and contacts an axial bottom of the notch 63, the axial bottom forms a stop to prevent further downward displacement of the collar 40 relative to the closure 60.

A fixed end of the hinged arm (also known as a “lamellar member”) 42 located at the annular base 48 forms a hinge axis, allowing the hinged arm 42 to deflect radially outwards about the fixed end, and the hinged arm 42 has an inclined top surface 421 at a free end thereof. The top surface 421 can engage with a lower surface of the annular flange 54 of the inner actuator 50, and as the inner actuator 50 moves downwards and pushes the top surface 421, the collar 40 also moves downwards. When the collar 40 moves relative to the closure 60 until the top surface 421 of the hinged arm 42 reaches an upper edge of the window 64 of the closure 60, the inclined top surface 421 is pressed by the annular flange 54, causing the hinged arm 42 to deflect outwards into the window 64. As the inner actuator 50 further moves downwards such that the inner surface of the hinged arm 42 is pressed by the annular flange 54, the hinged arm 42 further deflects outwards through the window 64. The plurality of hinged arms 42 are generally located on the same circumference and can be formed by the same annular wall. Moreover, it can be realized that since the outer legs 43 are engaged in the axial grooves 62 of the closure 60 and the hinged arms 42 bear against the inner surface of the annular wall 61 of the closure 60, the circumference of the hinged arms 42 is slightly smaller than that of the outer legs 43.

The plurality of pairs of tabs 45 are located radially outside the inner sleeve 46 and are generally on the same circumference. The plurality of pairs of tabs 45 can be formed from the same annular wall. Each pair of tabs 45 is forked, that is, spaced apart from each other in a circumferential direction. Each pair of tabs 45 can slide axially in one axial groove 74 of the bushing 70, that is, circumferential outer sides of each pair of tabs 45 slidably engage with both sides of the respective axial groove 74. Each pair of tabs 45 has a pair of circumferentially protruding upper projections 451 and a pair of circumferentially protruding lower projections 452 on circumferential outer sides thereof, and the upper projection 451 and lower projection 452 on each side are axially spaced apart. The pair of upper projections 451 of each pair of tabs 45 extend in opposite directions, and the pair of lower projections 452 of each pair of tabs 45 also extend in the opposite directions. During the axial displacement of the collar 40 relative to the bushing 70, the upper projections 451 and the lower projections 452 can engage with the groove flanges 75 of the bushing 70. Moreover, since there is a gap between each pair of tabs 45, each pair of tabs 45 can be slightly elastically deformed towards each other, thereby making it possible that the upper projections 451 passes over the groove flanges 75 during the axial displacement of the collar 40 relative to the bushing 70. Preferably, the upper projection 451 (or, both the upper projection 451 and the lower projection 452) has a horizontal upper surface and an inclined lower surface, so that as the collar 40 is displaced downwards relative to the bushing 70, the upper projection 451 can easily pass over the groove flange 75, and hereafter, under the action of the spring 90, the upper surface of the upper projection 451 may bear against the groove flange 75.

The figure shows three outer legs 43, three inner ribs 41, three hinged arms 42, and three pairs of tabs 45, but more or less number of the features is conceivable, as long as these features have the same number as the features matching them. The plurality of outer legs 43, the plurality of inner ribs 41, the plurality of hinged arms 42, or the plurality of pairs of tabs 45 (and the features matching them) can be uniformly distributed in the circumferential direction.

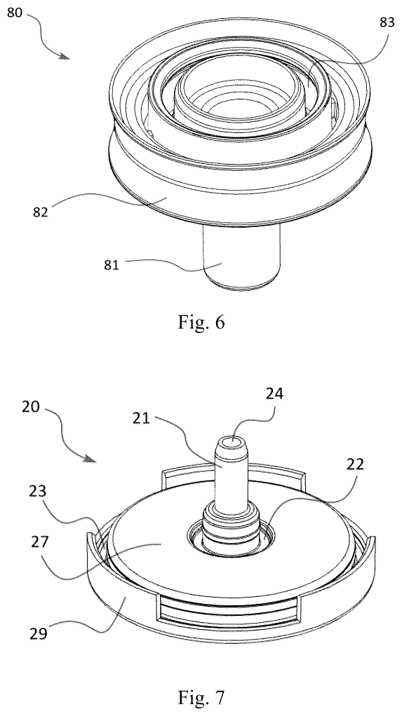

Referring to FIG. 6 in conjunction with FIG. 1, the piston 80 comprises a piston body, a central sleeve 81 extending downwards from the piston body, a sealing lip 82 located on the periphery of the piston body, and an annular groove 83 arranged on a upper side of the piston body. The lower end of the inner sleeve 46 of the collar 40 can be engaged into the annular groove 83 to push the piston 80 to axially displace. The sealing lip 82 slidably engages with the inner surface of the cylinder section 72 of the bushing 70 in a sealing manner. The central sleeve 81 at least partially accommodates a lower end of the pump body 31 of the pump 30.

Referring to FIG. 7 in conjunction with FIG. 1, the sealing cap 20 comprises a cap body 27, a hollow shaft 21, an inner groove 22, an outer groove 23, and a peripheral lip 29. The hollow shaft 21 extends upwards from the cap body 27 into the central sleeve 81 of the piston 80, and is sealed and slidably inserted into an inlet at a bottom of the pump body 31. The hollow shaft 21 defines a hole 24 that communicates the inlet 33 of pump 30 with the first reservoir 11. The inner groove 22 is arranged on the upper side of the cap body 27 around the hollow shaft 21, and the lower end of the central sleeve 81 of the piston 80 is sealed and engaged in the inner groove 22. The outer groove 23 is arranged on the upper side of the cap body 27 and is radially spaced outwards relative to the inner groove 22, and the lower end of the cylinder section 72 of the bushing 70 is sealed and engaged in the outer groove 23. The peripheral lip 29 guides the cylinder section 72 of the bushing 70 into the outer groove 23. It will be appreciated that the axial displacement of the pump body 31, the collar 40, and the piston 80 causes the displacement of the sealing cap 20, and then the second reservoir 12 is opened to allow the second product within the second reservoir 12 to fall into the first reservoir 11 containing the first product for mixing. Finally, liquid is drawn through the hole 24 of the sealing cap 20 towards the inlet of the pump body 31. A suction tube (not shown) can be positioned on the hole 24. In this embodiment, such a suction tube is not used. It can be seen that through the sealing connection between the central sleeve 81 of piston 80 and the sealing cap 20, the pump body 31 of pump 30 is completely separated from the second reservoir, so that during filling the second reservoir, the pump body 31 is avoided from coming into contact with the second product. Moreover, due to the fact that the central sleeve 81 of piston 80 extends far from the bottom of pump body 31, the volume of the second product filled in the second reservoir 12 can increase compared to the design where the pump bottom is not nested within the sleeve of the piston. This is because in the latter design, the height (or liquid level) of the product cannot reach the axial position of the inlet of the pump body.

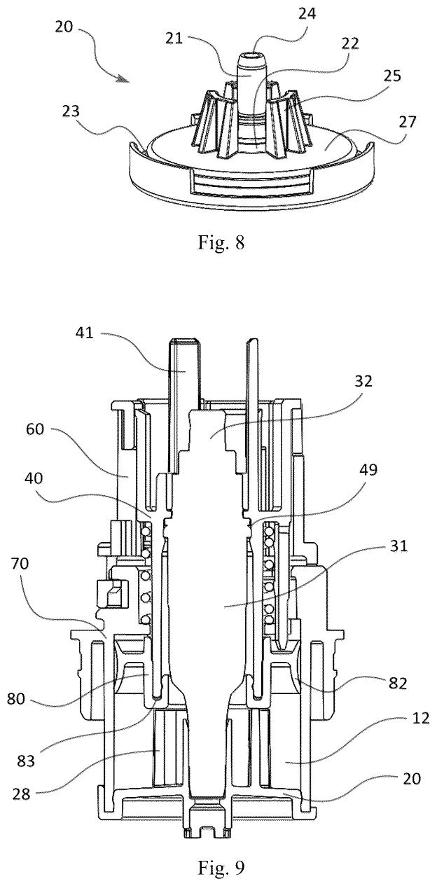

Referring to FIG. 8, in a variant of the sealing cap 20, a plurality of support ribs 25 extend upwards from the cap body 27, and surround and bear against the central sleeve 81 of the piston 80.

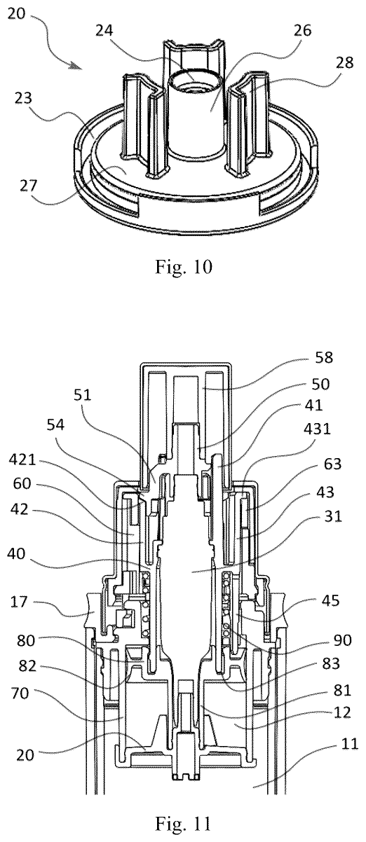

Referring to FIGS. 9 and 10, a second embodiment of the dispenser according to the present invention is shown. The second embodiment is different from the first embodiment mainly in the piston and the sealing cap. Specifically, the piston is not provided with a central sleeve that surrounds the bottom of the pump body, and the sealing cap is not provided with a shaft that passes into the bottom of the pump body. As shown in FIG. 10, the sealing cap 20 comprises a cap body 27, a cap sleeve 26, an outer groove 23, and a plurality of cap ribs 28. The cap sleeve 26 extends upwards from the cap body 27, defines the hole 24 that communicates the inlet 33 of the pump 30 with the first reservoir 11, and sleeves over the bottom of the pump body 31 in a sealing manner. The outer groove 23 is arranged in the upper surface of the cap body 27 to engage with the lower end of the cylinder section 72 of the bushing 70 in a sealing manner. The plurality of (e.g., three) cap ribs 28 extend upwards from the cap body 27 and evenly surround the cap sleeve 26 in a circumferential direction. As shown in FIG. 10, the upper end of the cap rib 28 abuts the bottom surface of the piston 80, allowing it to be pushed by the piston 80 to displace downwards. The piston 80 comprises a sealing lip 82 which can seal and slidably engage with the inner surface of the cylinder section 72 of the bushing 70, and an annular groove 83 in which the lower end of the inner sleeve 46 of the collar 40 is engaged.

At this point, the second reservoir 12 is defined by the wall of the cylinder section 72 of the bushing 70, the sealing cap 20, the piston 80, the pump body 31, and a body of the collar 40. In fact, the second reservoir 12 extends to the sealed snapped connection (i.e., at the snap groove 49) between the collar 40 and the pump body 31. When the sealing cap 20 is positioned on the bushing 70, it slightly axially displaces after the second reservoir 12 is sealed, thereby reducing the volume of the second reservoir 12 without any possibility of air escape. The pressure within the second reservoir 12 then increases. Three cap ribs 28 simultaneously push the piston 80 to increase the volume of the second reservoir 12, thereby balancing the increase in pressure. Of course, the cap ribs 28 can also be implemented on the sealing cap in the first embodiment.

The first reservoir and the second reservoirs are separately filled. Firstly, before the components are installed onto the first housing, the first reservoir with the upper end being open is filled with the first product. Then, the dispenser assembled with the remaining components (for example, including the second housing and various operating components, but excluding the sealing cap) is inverted, so that a bottom of the cylinder section 72 of the bushing 70 is open upwards, and then, the second reservoir defined by the cylinder section 72 is filled with the second product, and the sealing cap 20 is installed onto the cylinder section 72 to close the second reservoir. Finally, the dispenser with the remaining components is installed onto the first housing to complete filling and assembling operations.

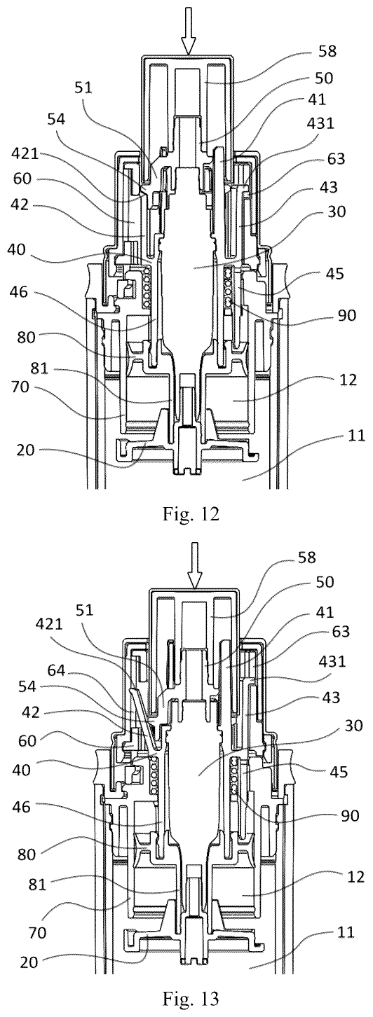

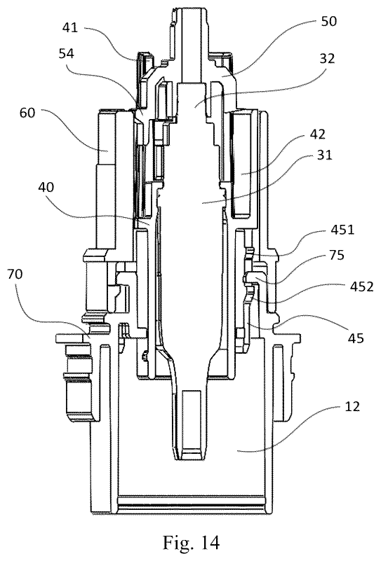

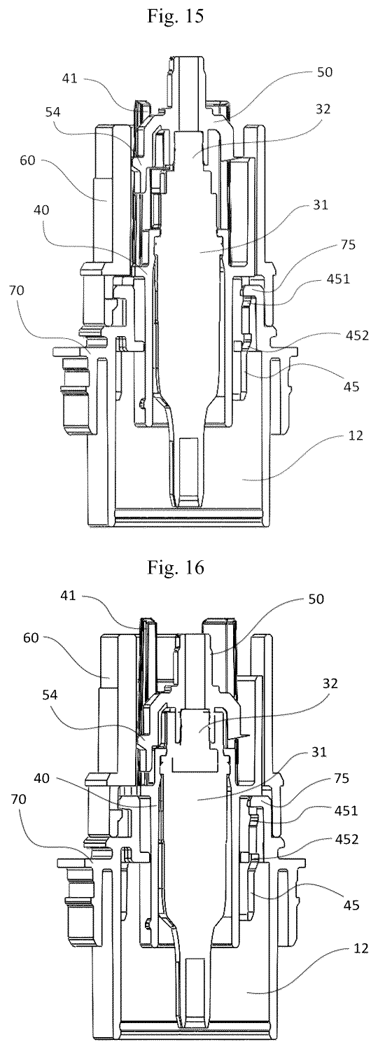

The operation process of the dispenser I will now be described with reference to FIGS. 11-16. The dispenser 1 is configured to have a first configuration shown in FIGS. 11 and 14, a second configuration shown in FIGS. 12 and 15, and a third configuration shown in FIGS. 13 and 16. In the first configuration, the actuator 5 is not pushed, and the first reservoir 11 is separated from the second reservoir 12 by the sealing cap 20. In the second configuration, the actuator 5 is pushed to cause axial displacement of the collar 40 and the piston 80, thereby pushing the sealing cap 20 to disengage from the bushing 70, such that the second product enters the first reservoir 11 to mix with the first product and form a mixture. In the third configuration, the actuator 5 is further pushed to activate the pump 30, thereby dispensing the mixture.

Referring to FIGS. 11 and 14, the first configuration is shown where the actuator 5 is not pushed (i.e. before the second reservoir 12 is opened). In the first configuration, the first and second products are stored in the respective first and second reservoirs. At this time, the annular flange 54 of the inner actuator 50 rests on the inclined top surfaces 421 of the hinged arms 42 of the collar 40. The outer legs 43 of the collar 40 is positioned in the axial grooves 62 of the closure 60, and the projections 431 at the upper ends of the outer legs 43 are located at entrances of the notches 63 of the closure 60. The inner ribs 41 of the collar 40 are located in the recesses 52 of the inner actuator 50. The pump body 31 is in its uppermost position, and the second reservoir 12 is sealed and closed. The spring 90 biases the collar 40 upwards. Under the action of the spring 90, the lower projection 452 of each tab 45 abuts against the lower surface of the groove flange 75 of the axial groove 74 of the bushing 70, as shown in FIG. 14. Therefore, the dispenser 1 is in a stable axial configuration.

Referring to FIGS. 12 and 15, the second configuration is shown where the actuator 5 is pushed but the pump 30 is not activated. In the second configuration, the second reservoir 12 is opened, allowing the second product to enter the first reservoir 11 to mix with the first product. Specifically, as the user pushes (e.g., presses down) the outer actuator 58, the outer actuator 58 pushes the inner actuator 50. Due to the contact between the annular flange 54 of the inner actuator 50 and the inclined top surfaces 421 of the hinged arms 42 of the collar 40, the inner actuator 50 pushes the collar 40. The hinged arms 42 radially abut against the inner surface of the annular wall 61 of the closure 60, and are subsequently held radially. The inner actuator 50 and the collar 40 are axially displaced relative to the closure 60. The axial displacement is guided by the inner ribs 41 of the collar 40 located in the recesses 52 of the inner actuator 50, the projections 431 on the outer legs 43 of the collar 40 traveling in the notches 63 of the closure 60, and the outer legs 43 of the collar 40 sliding in the axial grooves 62 of the closure 60. The axial displacement of the collar 40 pushes the piston 80 downwards to push the sealing cap 20 downward, thereby opening the second reservoir 12 and causing the second product to fall into the first reservoir 11 containing the first product. At this point, the second product can enter the first reservoir 11 by gravity for mixing, and the user can also shake the dispenser to accelerate the mixing process, especially in the case of powder products. The displacement of the collar 40 is carried out by resisting against the biasing action of the spring 90 located between the bushing 70 and the collar 40. The lower projection 452 of the tab 45 of the collar 40 disengages from the lower surface of the groove flange 75 of the bushing 70, and then the upper projection 451 approaches and passes over the groove flange 75, and abuts on the lower surface of the groove flange 75 under the upward biasing action of the spring 90, as shown in FIG. 15. In this position, the pump 30 is still not started (specifically, the stem 32 is not pressed), in other words, the pump 30 has not been activated.

Referring to FIGS. 13 and 16, the third configuration is shown where actuator 5 is further pushed to start the pump 30. In the third configuration, the pump 30 dispenses the mixed products. Specifically, further action of the user on the outer actuator 58 causes slight displacement of the collar 40 relative to the closure 60, such that the tilted top surfaces 421 of the hinged arms 42 face the windows 64 of the closure 60. In this position, the projections 431 of the outer legs 43 of the collar 40 abut on the bottom surfaces of the notches 63 of the closure 60, and the top surface of the bushing 70 abuts on the lower surface of the shoulder 47 of the collar 40. When the collar 40 cannot be further displaced relative to the closure 60, further action of the user on the outer actuator 58 causes the hinged arms 42 of the collar 40 to rotate about the respective hinge axes and pass through the windows 64 of the closure 60. This action is achieved initially by interacting between the annular flange 54 of the inner actuator 50 and the inclined top surfaces 421 of the hinged arms 42, and then by sliding the annular flange 54 of the inner actuator 50 along the inner surfaces of the hinged arms 42. The hinged arms 42 begin to deform about the respective hinge axes to form hard stops to be overcome, which transmits force feedback to the user to indicate that the pump 30 begins to start (first actuation). Since the pump body 31 is snapped in the collar 40, it is axially fixed relative to the collar 40. The inner actuator 50 is then displaced relative to the pump 30, and the stem 32 on which the inner actuator 50 is fixed is activated. This realizes dispense of the mixed products. The hinged arms 42 remain exactly in this position after activation, so that the user will not feel the hard point mentioned above during further actuation. In addition, as the inner actuator 50 displaces downwards, the shoulder 57 of the inner actuator 50 can bear against the top surface of the inner sleeve 46 of the collar 40 to completely prevent further downward movement of the actuator.

As shown in FIG. 16, in the third configuration, the upper projections 451 of the tabs 45 of the collar 40 disengage from the lower surfaces of the groove flanges 75 of the bushing 70. After the user releases the outer actuator 58, the collar 40 displaces upwards under upward biasing action of the spring 90, so that the upper projections 451 of the tabs 45 abut on the lower surfaces of the groove flanges 75 again. At the same time, the stem 32 of the pump 30 also displaces upwards under biasing action of a spring inside the pump and brings the actuator 5 out to eject upwards, such that the dispenser returns to the configuration shown in FIG. 15 at the end of the mixing operation to wait for the next dispensing operation. That is to say, the dispenser has the same configuration after the end of the mixing operation and after the end of one dispensing operation. As such, after the dispenser is initially activated and the products are mixed, the user can dispense the mixed products several times over a period of time.

The technical features of the embodiments described above may be arbitrarily combined, and for the sake of brevity, all possible combinations of the technical features in the embodiments described above are not described, but should be considered as being within the scope of the present specification as long as there is no contradiction between the combinations of the technical features.

The above embodiments only express several embodiments of the present invention, and the description thereof is more specific and detailed, but not construed as limiting the scope of the present invention. It should be noted that, for a person skilled in the art, several variations and modifications can be made without departing from the inventive concept, which falls within the scope of the present invention. Therefore, the protection scopes of the present patent shall be defined by the appended claims.

### List Of Reference Signs:

1 dispenser
10 cap
11 first reservoir
12 second reservoir
13 first housing
14 second housing
15 follower piston
17 outer ring
18 nozzle
20 sealing cap
21 hollow shaft
22 inner groove
23 outer groove
24 hole
25 support rib
26 cap sleeve
27 cap body
28 cap rib
29 peripheral lip
30 pump
31 pump body
32 stem
33 inlet
34 outlet
40 collar
41 inner rib
42 hinged arm
421 top surface
43 outer leg
431 projection
44 outer surface
45 tab
451 upper projection
452 lower projection
46 inner sleeve
47 shoulder
48 annular base
49 snap groove
5 actuator
50 inner actuator
51 lower leg
52 recess
53 hollow column
54 annular flange
55 lower sleeve
56 base
57 shoulder
58 outer actuator
60 closure
61 annular wall
62 axial groove
63 notch
64 windows
65 annular flange
70 bushing
71 barrel section
72 cylinder section
73 annular outer flange
74 axial groove
75 groove flange
76 annular inner flange
77 outer sleeve
80 piston
81 central sleeve
82 sealing lip
83 annular groove
90 spring

1. A dispenser, comprising:
a first reservoir;
a second reservoir partially located within the first reservoir;
an actuator;
a bushing having a lower end which partially extends into the first reservoir;
a collar engaged with the actuator such that the collar can be pushed by the actuator to axially move, wherein the collar has a lower end partially extending into the bushing;
a pump fixedly arranged within the collar, and having an inlet which is in communication with the first reservoir, and an outlet which is in communication with a nozzle;
a piston engaged with the lower end of the collar, and configured to be pushed by the collar to slide within the bushing in a sealed manner; and
a sealing cap engaged with the lower end of the bushing in a sealed manner, and configured to be pushed by the piston;
wherein the second reservoir is defined by the bushing, the piston, and the sealing cap; and
wherein the dispenser is configured to have a first configuration in which the actuator is not pushed and the first reservoir is separated from the second reservoir by the sealing cap, and a second configuration in which the actuator is pushed to axially displace the collar and the piston such that the sealing cap is pushed to disengage from the bushing, and a third configuration in which the actuator is further pushed to activate the pump.

2. The dispenser according to claim 1, further comprising a spring located between the bushing and the collar wherein the spring biases the collar axially.

3. The dispenser according to claim 2, wherein the collar comprises an inner sleeve, and an annular base located on an outer surface of the inner sleeve, and wherein a pump body of the pump is fixedly arranged within the inner sleeve, and the piston is engaged with a lower end of the inner sleeve.

4. The dispenser according to claim 3, further comprising a closure arranged around the collar, wherein the closure comprises an annular wall and a plurality of axial grooves arranged along an inner surface of the annular wall, and wherein the collar comprises a plurality of outer legs extending axially upwards from the annular base and each of the plurality of outer legs slidably engages into an axial groove of the plurality of axial grooves.

5. The dispenser according to claim 4, wherein an outer leg of the collar comprises a projection protruding radially outwards from a top of the outer leg, wherein the closure comprises a notch located at an upper end of the axial groove, and wherein in the third configuration of the dispenser the projection slidably engages the notch to allow axial displacement of the collar relative to the closure and an axial bottom of the notch forms a stop for the projection to prevent further axial displacement of the collar relative to the closure.

6. The dispenser according to claim 4, wherein the actuator comprises an outer actuator operated by the user, and an inner actuator fixedly connected to the outer actuator, wherein the inner actuator has a plurality of lower legs extending axially downwards, the adjacent lower legs being separated by a recess, and wherein the collar has a plurality of inner ribs extending axially upwards from the annular base and the inner ribs are located radially inside the respective outer legs and axially slidably engage into the recesses.

7. The dispenser according to claim 6, wherein the collar further comprises hinged arms each located between the adjacent outer legs and extending axially upwards from the annular base, the hinged arms being deflectable outwards about a fixed end thereof, and having an inclined top surface at a free end thereof, wherein the inner actuator comprises an annular flange located on outer surfaces of the lower legs, and wherein the annular flange and the hinged arms are configured so that in the first configuration and the second configuration of the dispenser, a lower surface of the annular flange engages with the top surfaces of the hinged arms.

8. The dispenser according to claim 7, wherein the closure comprises windows located between the adjacent axial grooves and radially perforating through the annular wall, wherein the annular flange, the hinged arms, and the windows are configured so that in the third configuration of the dispenser the lower surface of the annular flange slides along the top surfaces of the hinged arms and inner surfaces of the hinged arms to deflect the hinged arms outwards through the respective windows.

9. The dispenser according to claim 6, wherein the inner actuator comprises a shoulder located on inner surfaces of the lower legs, wherein as the inner actuator displaces downwards, the shoulder of the inner actuator abuts against a top surface of the inner sleeve of the collar.

10. The dispenser according to claim 3, wherein the collar comprises a plurality of pairs of tabs extending axially downwards from the annular base, the plurality of pairs of tabs being located radially outside the inner sleeve and each pair of tabs being spaced circumferentially, wherein the bushing comprises a barrel section which defines a plurality of axial grooves on an inner surface thereof, and wherein each pair of tabs axially slidably engage into the respective axial groove.

11. The dispenser according to claim 10, wherein each pair of tabs has a pair of circumferentially protruding upper projections and a pair of circumferentially protruding lower projections on a circumferential outer side thereof, wherein each axial groove of the bushing is provided with a pair of circumferential opposite groove flanges at an upper end thereof, and wherein the upper projections, the lower projections, and the groove flanges are configured so that in the first configuration of the dispenser upper sides of the pair of lower projections abut against lower sides of the respective pair of groove flanges, and in the second configuration of the dispenser, the pair of upper projections are axially displaced downwards to pass over the respective pair of groove flanges, and the upper sides of the pair of upper projections abut against lower sides of the respective pair of groove flanges.

12. The dispenser according to claim 11, wherein a lower surface of the annular base of the collar forms a shoulder, wherein as the collar displaces downwards, the shoulder of the collar abuts against a top surface of the bushing.

13. The dispenser according to claim 12, wherein an inner surface of the barrel section of the bushing is provided with an annular inner flange, and wherein the spring is arranged between the annular inner flange of the bushing and the shoulder of the collar.

14-22. (canceled)

23. The dispenser of claim 1, further comprising a first product in the first reservoir and a second product in the second reservoir.

24. The dispenser of claim 23, wherein the first product is mixed with the second product during the second configuration.

25. A dispenser, comprising:
a first reservoir;
a first product in said first reservoir;
a second reservoir;
a second product in said second reservoir;
an actuator;
a bushing having a lower end which partially extends into the first reservoir;
a collar engaged with the actuator such that the collar can be pushed by the actuator to axially move, wherein the collar has a lower end partially extending into the bushing;
a pump fixedly arranged within the collar and having an inlet which is in communication with the first reservoir and an outlet which is in communication with a nozzle;
a piston engaged with the lower end of the collar and configured to be pushed by the collar to slide within the bushing in a sealed manner; and
a sealing cap engaged with the lower end of the bushing in a sealed manner, and configured to be pushed by the piston;
wherein the second reservoir is defined by the bushing, the piston, and the sealing cap; and
wherein the dispenser is configured to have a first configuration in which the actuator is not pushed and the first reservoir is separated from the second reservoir by the sealing cap, and a second configuration in which the actuator is pushed to axially displace the collar and the piston such that the sealing cap is pushed to disengage from the bushing and the first product mixes with the second product, and a third configuration in which the actuator is further pushed to activate the pump.
